(19) United States
(12) Patent Application Publication
(10) Pub. No.: US 2013/0179372 A1
(43) Pub. Date: Jul. 11, 2013

(54) SYSTEM AND METHOD FOR AUTOMATIC PROVISIONING OF APPLICATIONS

(71) Applicants: Philip Schentrup, Hollywood, FL (US); Daniel Gittleman, Delray Beach, FL (US)

(72) Inventors: Philip Schentrup, Hollywood, FL (US); Daniel Gittleman, Delray Beach, FL (US)

(73) Assignee: OpenPeak Inc., Boca Raton, FL (US)

(21) Appl. No.: 13/346,592

(22) Filed: Jan. 9, 2012

(51) Int. Cl. G06F 15/16; G06Q 30/02

(52) U.S. Cl. 705/400; 709/217

(57) ABSTRACT

A method and system for automatic provisioning of applications are described herein. The method can include the step of offering a plurality of applications for download to electronic devices in which each of at least some of the applications may be formatted for one of a plurality of operating environments. The method can also include the steps of receiving a request for at least one application in which the request can be associated with a first electronic device and selecting an application for delivery to the first electronic device. The selected application can be an application that may be formatted for the operating environment of the first electronic device and may be among the offered applications that are formatted for differing operating environments.

### FIELD OF TECHNOLOGY

The present subject matter relates to systems and methods for providing and delivering applications to computing devices.

### BACKGROUND

The use of applications, commonly referred to as “apps,” has become prevalent over the past few years. To meet this demand, several entities have developed services to enable users of mobile devices to download applications to such devices. For example, Apple, Inc. of Cupertino, Calif. offers an interface to permit applications to be uploaded from application developers and for users to search, select and possibly purchase applications for download to Apple devices. As part of this process, the company offers a software development kit (SDK) to developers for guidance on creating these applications, and the applications must be approved by Apple before being made available to users. In addition, Apple shares with the application developers the revenue that is generated by the downloads. Other companies, such as Google, Inc. of Mountain View, Calif. and Research In Motion, Ltd., of Waterloo, Ontario, Canada, also offer interfaces for developers to create and upload applications and for users to retrieve such software.

Thus, there are multiple companies that offer this service, and it is expected that the number of them doing so will increase. As a result, in some cases, there are multiple formats for the same application. For example, a developer may create an application for iOS, Apple's mobile operating system, and for Android, the platform associated with Google. That is, there may be two versions for the same application, and the number of versions will increase if development is extended to other competing operating systems. In addition, each of these versions will typically be uploaded into a respective application store.

Some users may possess or manage multiple mobile devices, each loaded with a different operating system. If the user wishes to install the same application for each mobile device, the user is currently required to separately download the application from each application store that is associated with the particular operating system that is installed on a mobile device. Accordingly, the user must solicit multiple application stores, and possibly pay an identical fee numerous times, to install the same application on a plurality of devices.

### SUMMARY

A method for automatic provisioning of applications is described herein. The method can include the step of offering a plurality of applications for download to electronic devices in which each of at least some of the applications are formatted for one of a plurality of operating environments. The method can also include the steps of receiving a request for at least one application in which the request is associated with a first electronic device and selecting an application for delivery to the first electronic device. The term “associated with a first electronic device” means that the request may originate from the first electronic device or from another device on behalf of the first electronic device. The selected application can be an application that is formatted for the operating environment of the first electronic device and can be among the offered applications that are formatted for differing operating environments.

In one arrangement, the request for the application can be associated with a second electronic device in addition to the first device. For example, the request for the application that is associated with both the first electronic device and the second electronic device can be received from the first electronic device. In view of the above, the method can further include the step of selecting an application for delivery to both the first electronic device and the second electronic device. The selected application to be delivered to the first electronic device can be an application that is formatted for the operating environment of the first electronic device, and the selected application to be delivered to the second electronic device can be an application that is formatted for the operating environment of the second electronic device. The operating environment of the first electronic device can be different from the operating environment of the second electronic device.

The method can further include the step of charging a fee for the delivery of the application to the first electronic device and to the second electronic device. Charging the fee can include charging a bulk delivery fee for the delivery of the application to the first electronic device and the second electronic device.

The method can also include the step of determining the operating environment of the first electronic device for selecting the application for delivery to the first electronic device. In one example, the electronic devices can be mobile communication devices, and the operating environments can include operating systems that are loaded on the mobile communication devices. In another arrangement, offering the plurality of applications for download can include offering the plurality of applications for download at an electronic application store. The method can also include the step of segmenting the offered applications in the electronic application store based on the operating environments for which the offered applications are formatted.

Another method for automatic provisioning of applications to a plurality of electronic devices having different operating environments is described herein. This method can include the step of offering a plurality of applications for download to the electronic devices in which each of at least some of the offered applications are formatted for one of the different operating environments of the electronic devices. The method can also include the steps of receiving a request for an application for a first electronic device and a second electronic device in which each of at least some of the offered applications are formatted for one of the different operating environments of the electronic devices and selecting the application for delivery to the first electronic device and the second electronic device. The application to be delivered to the first electronic device can be an application that is formatted for the operating environment for the first electronic device, and the application to be delivered to the second electronic device can be an application that can be formatted for the operating environment of the second electronic device.

In one arrangement, the request for the application can be received from the first electronic device. In addition, the method can further include the step of filtering the plurality of applications that are offered for download to the electronic devices based on the different operating environments of the electronic devices such that only applications that are formatted for the operating environment of the first electronic device and for the operating environment of the second electronic device are offered for download. The method can also include the step of determining the operating environment of the first electronic device and the second electronic device for selecting the application for delivery to the first electronic device and the second electronic device. In another arrangement, the plurality of applications for download can be offered at an electronic application store, and the method can further include the step of segmenting the offered applications in the electronic application store based on the operating environments for which the offered applications are formatted.

Yet another method for automatic provisioning of applications to a plurality of electronic devices having different operating environments is described herein. This method can include the step of—at an electronic application store—offering a plurality of applications for download to the electronic devices in which each of the offered applications can be formatted for one of the different operating environments of the electronic devices. The method can also include the step of receiving—at the electronic application store—a request for a download of an application to a first electronic device and to a second electronic device in which the first electronic device and the second electronic device have different operating environments. The method can further include the step of selecting the application for delivery to the first electronic device and the second electronic device. The application to be delivered to the first electronic device can be a version of the application that is formatted for the operating environment for the first electronic device, and the application to be delivered to the second electronic device can be a version of the application that is formatted for the operating environment for the second electronic device.

A system for automatic provisioning of applications is also described herein. In one arrangement, the system can include an application memory component that can be operable to store a plurality of applications for download to electronic devices. Each of at least some of the applications can be formatted for one of a plurality of operating environments of the electronic devices. The system can also include an interface that is operable to receive a request for at least one application in which the request is associated with a first electronic device. The system can further include a processing unit that can be communicatively coupled to the application memory component and the interface. The processing unit can be operable to select an application for delivery to the first electronic device in which the selected application can be an application that is formatted for the operating environment of the first electronic device and can be among the offered applications that are formatted for differing operating environments.

The request received by the interface can be a request that can also be associated with a second electronic device, and the second electronic device may have an operating environment that is different from the operating environment of the first electronic device. In one arrangement, the request received by the interface can be transmitted from the first electronic device on behalf of both the first electronic device and the second electronic device. Alternatively, the request can be transmitted from a component that is separate from the first electronic device and the second electronic device on behalf of both the first electronic device and the second electronic device.

The processing unit can be further operable to select an application for delivery to both the first electronic device and the second electronic device. The selected application to be delivered to the first electronic device can be an application that can be formatted for the operating environment of the first electronic device, and the selected application to be delivered to the second electronic device can be an application that can be formatted for the operating environment of the second electronic device.

The processing unit can be further operable to determine a bulk delivery fee for the delivery of the application to the first electronic device and the second electronic device. In another arrangement, the processing unit can be further operable to determine the operating environment of the first electronic device and the second electronic device for selecting the application for delivery to the first electronic device and to the second electronic device. In yet another arrangement, the application memory component, the interface and the processing unit can be part of an electronic application store that offers the plurality of applications for download to the electronic devices. As an example, the application memory component can be operable to segment the offered applications of the electronic application store based on the operating environments for which the offered applications are formatted. As another example, the electronic devices can be mobile communication devices, and the operating environments can include operating systems that are loaded on the mobile communication devices.

Another system for automatic provisioning of applications to a plurality of electronic devices having different operating environments is described herein. The system can include an application memory component that is operable to store a plurality of applications for download to electronic devices. Each of at least some of the applications can be formatted for one of a plurality of operating environments of the electronic devices. The system can also include an interface that is operable to receive a request for at least one application for delivery to a first electronic device and a second electronic device. The operating environment of the first electronic device may be different from the operating environment of the second electronic device. The system can also include a processing unit that is communicatively coupled to the application memory component and the interface. The processing unit can be operable to select an application for delivery to the first electronic device and to the second electronic device. The application to be delivered to the first electronic device can be a version of the selected application that can be formatted for the operating environment of the first electronic device, and the application to be delivered to the second electronic device can be a version of the selected application that can be formatted for the operating environment of the second electronic device.

In one arrangement, the application memory component, the interface and the processing unit of this system can form part of an electronic application store that is accessible by the plurality of electronic devices having the different operating environments. In another arrangement, the interface can be further operable to receive the request for the application for delivery to the first electronic device and the second electronic device from the first electronic device or from another component separate from the first electronic device and the second electronic device.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 illustrates an example of a system for automatic provisioning of applications.

FIG. 2 illustrates an example of a method for automatic provisioning of applications.

FIG. 3 illustrates an example of a method for automatic provisioning of applications to a plurality of electronic devices having different operating environments.

Applicants expressly disclaim any rights to any third-party trademarks or copyrighted images included in the figures. Such marks and images have been included for illustrative purposes only and constitute the sole property of their respective owners.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

The following detailed description refers to the accompanying drawings that illustrate exemplary embodiments; however, the scope of the present claims is not limited to these embodiments. Thus, embodiments beyond those shown in the accompanying drawings, such as modified versions of the illustrated embodiments, may nevertheless be encompassed by the present claims.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to implement such feature, structure, or characteristic in connection with other embodiments whether or not explicitly described.

Several definitions that apply throughout this document will now be presented. The term “exemplary” as used herein is defined as an example or an instance of an object, apparatus, system, entity, composition, method, step or process. The term “communicatively coupled” is defined as a state in which two or more components are connected such that communication signals are able to be exchanged between the components on a unidirectional or bidirectional (or multi-directional) manner, either wirelessly, through a wired connection or a combination of both. An “electronic device” is defined as a powered component that is configured to perform some process or function for a user and includes both mobile and non-mobile devices. An “application” is defined as a program or programs that provide(s) an interface to enable a user to operate an electronic device in accordance with one or more particular tasks. The term “content” is defined as something that is expressed through some medium, including (but not limited to) applications, video, audio, URLs and documents. The term “operating environment” is defined as a particular setting that is associated with an electronic device and is used to control multiple operations and configurations of the electronic device.

The term “electronic application store” is defined as a platform that offers applications for delivery to an electronic device. The term “application memory component” is defined as one or more memory components that store and make accessible any number of applications available for delivery from an electronic application store. An “interface” is defined as a component or group of components that at least receive(s) signals from a first device and transfers those signals to a second device in a form that is compatible with the second device. A “processing unit” is defined as one or more components that execute(s) sets of instructions.

As noted earlier, applications are tailored to mobile devices loaded with a particular operating system. As such, a user must visit multiple applications stores and separately download, install and pay for applications for mobile devices loaded with different operating systems.

To overcome this inefficiency, a system and method for automatic provisioning of applications are described herein. In one arrangement, the method can include the step of offering a plurality of applications for download to electronic devices in which each of at least some of the offered applications are formatted for one of a plurality of operating environments, such as operating systems. The method can also include the steps of receiving a request for at least one application in which the request is associated with a first electronic device and selecting an application for delivery to the first electronic device. The selected application can be an application that is formatted for the operating environment of the first electronic device and is among the offered applications that are formatted for differing operating environments.

The request may also be for an application for both the first electronic device and a second electronic device in which the first electronic device and the second electronic device have different operating environments. In this case, the application can be selected for delivery to both the first electronic device and the second electronic device. In addition, the application to be delivered to the first electronic device can be an application that is formatted for the operating environment of the first electronic device, and the application to be delivered to the second electronic device can be an application that is formatted for the operating environment of the second electronic device.

As such, a user can visit a single application store and can select an application for download to one or more electronic devices, irrespective of whether the electronic devices include differing operating environments. The method and system presented herein can be particularly useful for a user who carries a plurality of mobile devices that are loaded with incompatible operating systems.

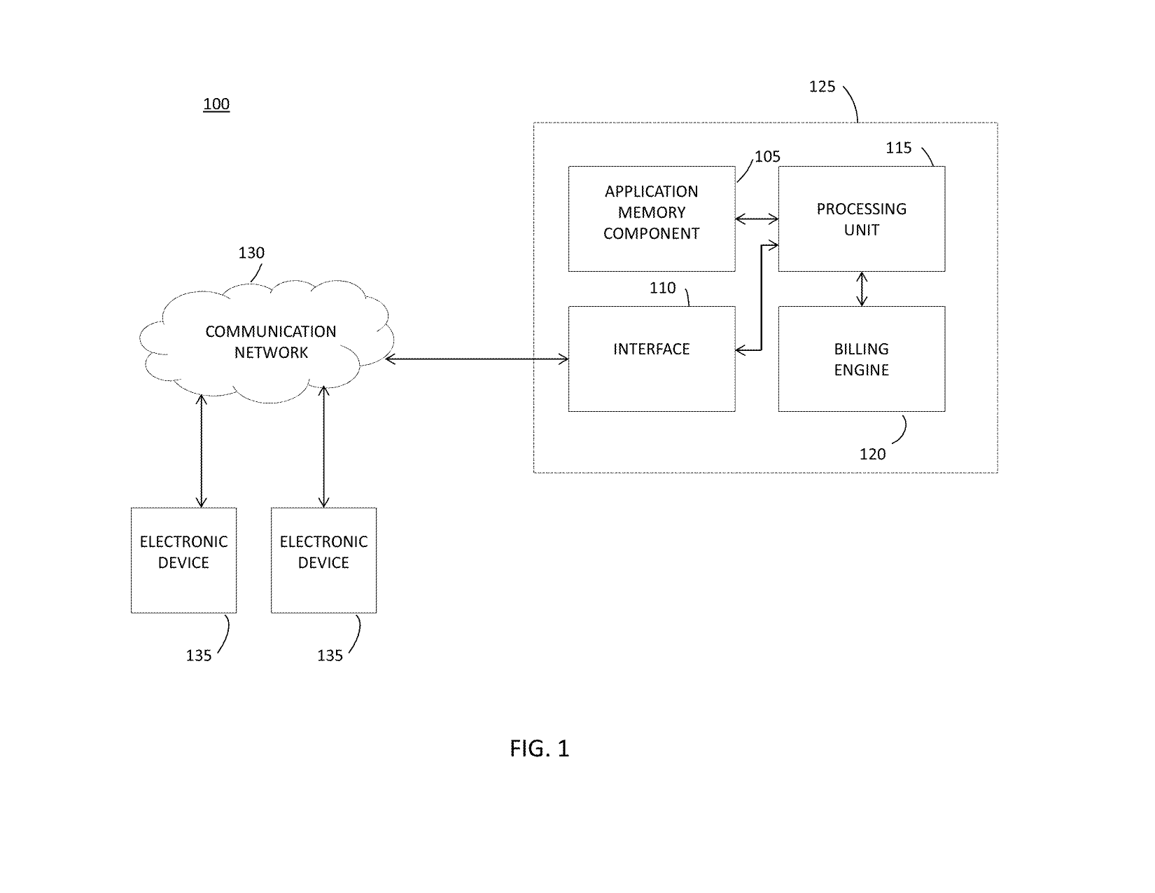

Referring to FIG. 1, an example of a system 100 for automatic provisioning of applications is shown. In one arrangement, the system 100 can include an application memory component 105, an interface 110, a processing unit 115 and a billing engine 120. The processing unit 115 can be communicatively coupled to the application memory component 105, the interface 110 and the billing engine 120. In one arrangement, the application memory component 105, the interface 110, the processing unit 115 and the billing engine 120 can be part of an electronic application store 125, which can be configured to offer applications for download. In one arrangement, the application store 125 can be communicatively coupled to a communication network 130, which can also be coupled to a plurality of electronic devices 135. The communication network 130 can be any network or group of networks capable of exchanging wired, wireless or a combination of wired and wireless signals between the application store 125 and the electronic devices 135.

In one embodiment, the application memory component 105 is operable or configured to store a plurality of applications for download to the electronic devices 135. In one particular embodiment, the application memory component 105 can store different versions of the same application, and these versions can be formatted to a specific operating environment. As an example, electronic devices 135 can be mobile or non-mobile devices, such as smartphones, tablets, laptops or desktop computers, and the operating environment can refer to the operating system that is installed on such a device 135. As such, the application memory component 105 can store applications that are formatted for numerous operating systems, both mobile and non-mobile types.

The interface 110 can serve to transfer signals between the application store 125 and the communication network 130 (or some other suitable component). Also, the processing unit 115 can be operable to select the appropriately formatted applications for delivery to the relevant electronic devices 135. The billing engine 120, which may be part of the processing unit 115 or may be a separate component, is operable to determine charges for application transactions, such as the purchase or licensing of applications from the application store 125. Additional details of the operation of the system 100 will be presented below.

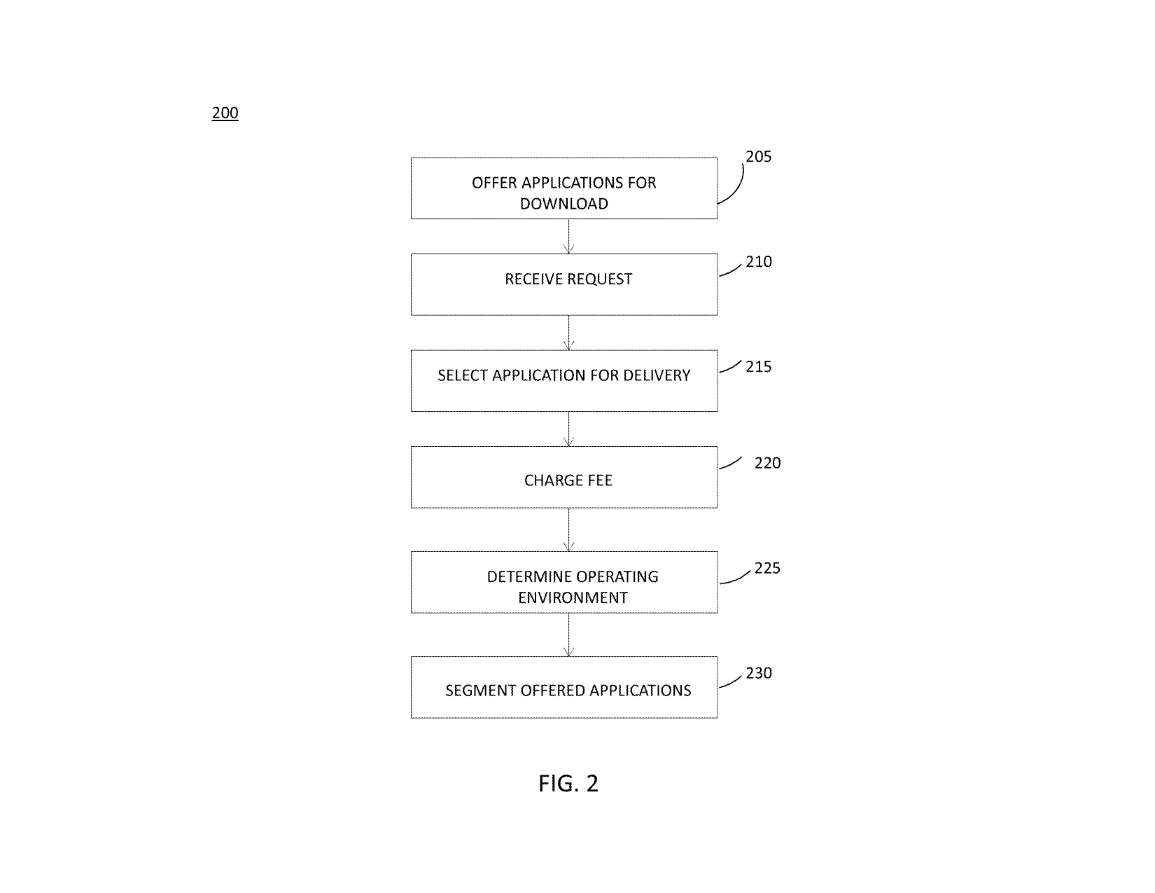

Referring to FIG. 2, a method 200 for automatic provisioning of applications is shown. To describe this method 200, reference will be made to the components of FIG. 1, although it is understood that the method 200 can be practiced using other suitable components and systems. Moreover, the method 200 may be practiced with other additional steps not shown in FIG. 2 or may be practiced with a fewer number of steps as shown in FIG. 2. It is also important to note that the method 200 is not necessarily limited to the chronological order established in FIG. 2.

At step 205, a plurality of applications can be offered for download to electronic devices, and at step 210, a request can be received for at least one of the offered applications. At step 215, an application can be selected for delivery to the electronic device. As an option, a fee can be charged for the delivery of the application to the electronic device, as shown in step 220. Further optional steps include determining the operating environment of the electronic device for selecting the application for delivery to the electronic device and the offered applications can be segmented based on operating environments, as shown respectively in steps 225 and 230.

For example, the electronic application store 125 can be arranged to accept and store applications of different formats for different operating environments. As a more specific example, application developers can create an application that may be presented in different versions in which each version of the application is compatible with a particular operating system. The different versions of the application can be provided to the application store 125, which can present an interface to enable users to access applications for electronic devices 135 irrespective of the operating environment of the electronic devices 135.

In one arrangement, the application memory component 105 can segment the applications based on the particular formatting of the applications. As such, for convenience, applications that are formatted for a particular operating environment can be stored and/or presented together, and those of different formats can be segregated from this particular grouping of applications.

To facilitate the delivery of applications to one or more electronic devices 135, it may be helpful to determine the operating environment of such devices 135. For example, a user of an electronic device 135 may wish to download one or more applications from the application store 125. When the electronic device 135 is communicatively coupled to the interface 110—through the communications network 130—the interface 110 can signal the processing unit 115 and can provide an indication as to the type of operating environment of the device 135. In response, the processing unit 115 can take steps to ensure that the applications that are formatted for the operating environment of the electronic device 135 are presented to the user. If the electronic device 135 is capable of supporting more than one operating environment, including an emulated or virtualized operating environment, the applications that are formatted for each of the supported operating environments can be presented to the user.

The user may select one or more applications for download from the application store 125, and the interface 110 can receive a request for the application. In response, the interface 110 can signal the processing unit 115, which can then select the requested application for delivery to the electronic device 135. The application selected can be an application that is formatted for the operating environment of the electronic device 135. Because the application memory component 105 can store different versions of an application, the selected application can be among offered applications that are formatted for differing operating environments. That is, the application store 125 can store and/or present applications of various formats and can enable the delivery of the appropriately formatted application for the requesting electronic device 135.

In the example described above, the request for the application was received from the electronic device 135. It is also possible that the request for the application may come from a component that is separate from the electronic device 135. For example, the electronic device 135 may be a mobile device, and a user may access the application store 125 from a desktop computer and request a download of a particular application to the mobile device. In this case, the user—through the desktop computer—can provide information to the application store 125 to enable the processing unit 115 to determine which format is relevant for the request. Once it receives the information, the processing unit 115 can select the application that is formatted for the mobile device for delivery to the device.

As part of the download of an application to the electronic device 135, the billing engine 120 may determine any fee that is involved with the transaction. This fee can be billed to the user or to some other suitable entity. In the case of multiple downloads, adjustments can be made to provide reduced billing rates or fees, examples of which will be presented below.

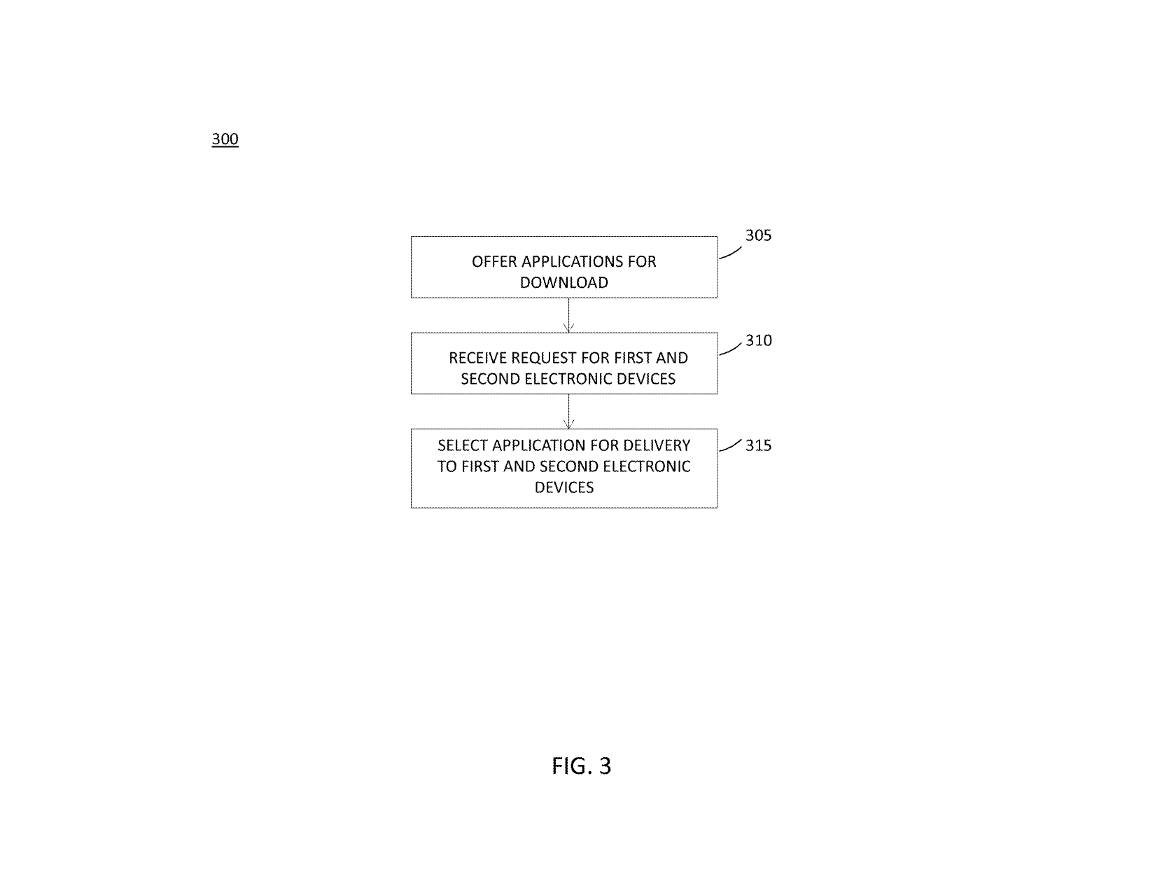

As presented above, the system 100 of FIG. 1 and the method 200 of FIG. 2 enable the application store 125 to provide applications of various formats to electronic devices 135 of differing operating environments. The description above is an example of a single electronic device 135 accessing an application from the application store 125 in which the selection of the application can be based on the operating environment of that device 135. Referring to FIG. 3, a method 300 for automatic provisioning of applications to a plurality of electronic devices having different operating environments is presented.

Like the method 200 of FIG. 2, to describe the method 300, reference will be made to the components of FIG. 1, although it is understood that the method 300 can be practiced using other suitable components and systems. Also similar to the method 200, the method 300 may be practiced with other additional steps not shown in FIG. 3 or may be practiced with a fewer number of steps as shown in FIG. 3. The method 300 is not necessarily limited to the chronological order established in FIG. 3.

At step 305, a plurality of applications can be offered for download to electronic devices, and at step 310, a request for an application for a first electronic device and a second electronic device can be received. The application can be selected for delivery to the first electronic device and the second electronic device, as shown at step 315.

For example, the electronic application store 125 can receive a request from a first electronic device 135 to download an application to the first electronic device 135 and to a second electronic device 135 in which the first device 135 and the second device 135 have different operating environments. Because the application store 125 offers different versions of offered applications, the processing unit 115 can select an application in a format that is compatible with the first device 135 for delivery to the first device 135. The processing unit 135 can also select the application in a different format that is compatible with the second device 135 for delivery to the second device 135. Thus, a user is capable of selecting an application from a single application store 125 for download to electronic devices 135 having different operating systems.

Consider a more specific example. A user may wish to download the same application to multiple electronic devices 135 in which at least some of the devices 135 have different operating systems. The user may, for example, access the application store 125 from a first electronic device 135 with a first operating system. The user may then select an application from the application store 125 and can provide information that can cause the application to be delivered to the first electronic device 135 and to a second electronic device 135 with a different operating system. This information about the second electronic device 135 can be provided at the time of or before the transaction. For example, the user can set up an account with the applications store 125 and can list one or more electronic devices 135—and (possibly) information about their operating environments—that are suitable for downloading applications from the applications store 125.

It is understood that any electrical device 135 can be used to cause the download of applications to other electrical devices 135. In the case above, the first electronic device 135 can initiate a download to itself and to the second electronic device 135. The first electrical device 135 can also direct the download of the application to the second device 135 without causing the download of the application to itself. Moreover, a third electrical device 135 can be used to cause the download of applications to both of the first and second electronic devices 135.

There are multiple ways to configure a user interface of the application store 125, particularly if electronic devices 135 having different operating environments are involved in a transaction. Consider the example where the first electronic device 135 having a first operating environment is being used to download an application to itself and to a second electronic device 135 having a second (i.e., different) operating environment. One or more icons or other graphical representations that represent the offered applications can be presented to the user. Selection of one or more of these icons or other graphical representations can initiate the download of the selected application to both of the first and second devices 135. That is, a single application representation can be presented to the user, and the user can select this representation to start the download of the application to multiple electronic devices 135 having different operating environments. When the single application representation is activated, the processing unit 115 can retrieve the different versions of the application from the application memory component 105 and direct the delivery of the application versions, as previously described.

In one arrangement, one or more indicators can be placed on or near the application representation to indicate whether a version of the application is available for a particular operating environment. For example, one or more icons representing the different operating environments that are supported by the application store 125 for a particular application can be placed on or near that application. This way, the user can quickly determine whether application versions are available in the application store 125 for various operating systems.

In another arrangement, the presentation or offering of the applications of the application store 125 can be filtered in accordance with any number of predefined settings. For example, a user may choose a filter setting in which only application representations are presented or offered for applications that are available in the application store 125 for the relevant electronic device 135. As a more specific example, if the user wishes to download an application for both first and second electronic devices 135 having different operating environments, then the user may set the application store 125 to present or offer for download only those applications that are available for both of the operating environments of the first and second electronic devices 135. In another arrangement, the user may be able to select a particular operating environment at the user interface of the application store 125, and only the applications that are available for that specific operating environment may be presented or offered for download.

As mentioned previously, the billing engine 120 can determine transaction fees, if they are relevant. In the case of multiple downloads, the billing engine 120 can determine and cause to be charged a bulk delivery fee for the delivery of the application to the plurality of electronic devices 135. Referring to the example above, a user may wish to download the same application to the first electronic device 135 and the second electronic device 135 that have different operating environments. In this case, the user may be required to pay a fee for the opportunity to download the application. Because multiple downloads are involved, the user may have to pay the same fee multiple times. To alleviate this burden, a bulk delivery fee may be imposed on the transaction in which the overall amount charged for multiple downloads of the same application is less than what would normally be charged for such a transaction. For example, if the transaction fee for downloading the application is normally $1.99 and a charge of $3.98 would normally be charged for the download to the first and second electronic devices 135, a fee below the normal charge of $3.98 may be imposed here. As the number of electronic devices 135 that are designated to receive the application increases, the discount provided by the bulk delivery fee can be increased.

The system can also be configured to accommodate different pricing structures for different operating systems. For example, a consumer may be charged a first fee and a second fee for the same application for different operating systems in which the first fee is higher or lower than the second fee.

It must also be stressed that the download of virtually any type of content is applicable here. Examples have been provided that show how different versions of the same application can be downloaded to electronic devices 135 that have different operating systems. Other content, however, may be downloaded to such devices in accordance with the description above. For example, the application store 125 or some other medium can offer different versions of the same multi-media content for delivery to a plurality of devices 135 with different operating systems. More specifically, a video or some other presentation may be offered and a user with two different electronic devices 135 having different operating systems may wish to obtain this video or presentation. The system described above can determine which version of this selected content is best appropriate for the two different devices 135 and can cause the delivery of such content to the devices 135.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method for automatic provisioning of applications, comprising:
offering a plurality of applications for download to electronic devices, wherein each of at least some of the applications are formatted for one of a plurality of operating environments;
receiving a request for at least one application, wherein the request is associated with a first electronic device; and
selecting an application for delivery to the first electronic device, wherein the selected application is an application that is formatted for the operating environment of the first electronic device and is among the offered applications that are formatted for differing operating environments.

2. The method according to claim 1, wherein the request for the application is associated with a second electronic device in addition to the first device.

3. The method according to claim 2, wherein the request for the application that is associated with both the first electronic device and the second electronic device is received from the first electronic device.

4. The method according to claim 2, further comprising selecting an application for delivery to both the first electronic device and the second electronic device, wherein the selected application to be delivered to the first electronic device is an application that is formatted for the operating environment of the first electronic device and the selected application to be delivered to the second electronic device is an application that is formatted for the operating environment of the second electronic device.

5. The method according to claim 4, wherein the operating environment of the first electronic device is different from the operating environment of the second electronic device.

6. The method according to claim 4, further comprising charging a fee for the delivery of the application to the first electronic device and to the second electronic device.

7. The method according to claim 6, wherein charging the fee further comprises charging a bulk delivery fee for the delivery of the application to the first electronic device and the second electronic device.

8. The method according to claim 1, further comprising determining the operating environment of the first electronic device for selecting the application for delivery to the first electronic device.

9. The method according to claim 1, wherein the electronic devices are mobile communication devices and the operating environments include operating systems that are loaded on the mobile communication devices.

10. The method according to claim 1, wherein offering the plurality of applications for download further comprises offering the plurality of applications for download at an electronic application store and the method further comprises segmenting the offered applications in the electronic application store based on the operating environments for which the offered applications are formatted.

11. A method for automatic provisioning of applications to a plurality of electronic devices having different operating environments, comprising:
offering a plurality of applications for download to the electronic devices, wherein each of at least some of the offered applications are formatted for one of the different operating environments of the electronic devices;
receiving a request for an application for a first electronic device and a second electronic device, wherein the first electronic device and the second electronic device have different operating environments; and
selecting the application for delivery to the first electronic device and the second electronic device, wherein the application to be delivered to the first electronic device is an application that is formatted for the operating environment for the first electronic device and the application to be delivered to the second electronic device is an application that is formatted for the operating environment for the second electronic device.

12. The method according to claim 11, wherein receiving the request for the application further comprises receiving the request for the application from the first electronic device.

13. The method according to claim 11, further comprising filtering the plurality of applications that are offered for download to the electronic devices based on the different operating environments of the electronic devices such that only applications that are formatted for the operating environment of the first electronic device and for the operating environment of the second electronic device are offered for download.

14. The method according to claim 11, further comprising determining the operating environment of the first electronic device and the second electronic device for selecting the application for delivery to the first electronic device and the second electronic device.

15. The method according to claim 11, wherein offering the plurality of applications for download further comprises offering the plurality of applications for download at an electronic application store and the method further comprises segmenting the offered applications in the electronic application store based on the operating environments for which the offered applications are formatted.

16. A method for automatic provisioning of applications to a plurality of electronic devices having different operating environments, comprising:
at an electronic application store, offering a plurality of applications for download to the electronic devices, wherein each of the offered applications are formatted for one of the different operating environments of the electronic devices;
receiving, at the electronic application store, a request for a download of an application to a first electronic device and to a second electronic device, wherein the first electronic device and the second electronic device have different operating environments; and
selecting the application for delivery to the first electronic device and the second electronic device, wherein the application to be delivered to the first electronic device is a version of the application that is formatted for the operating environment for the first electronic device and the application to be delivered to the second electronic device is a version of the application that is formatted for the operating environment for the second electronic device.

17. A system for automatic provisioning of applications, comprising:
an application memory component, wherein the application memory component is operable to store a plurality of applications for download to electronic devices, wherein each of at least some of the applications are formatted for one of a plurality of operating environments of the electronic devices;
an interface, wherein the interface is operable to receive a request for at least one application, wherein the request is associated with a first electronic device; and
a processing unit that is communicatively coupled to the application memory component and the interface, wherein the processing unit is operable to select an application for delivery to the first electronic device, wherein the selected application is an application that is formatted for the operating environment of the first electronic device and is among the offered applications that are formatted for differing operating environments.

18. The system according to claim 17, wherein the request received by the interface is a request that is also associated with a second electronic device and the second electronic device has an operating environment that is different from the operating environment of the first electronic device.

19. The system according to claim 18, wherein the request received by the interface is transmitted from the first electronic device on behalf of both the first electronic device and the second electronic device or is transmitted from a component that is separate from the first electronic device and the second electronic device on behalf of both the first electronic device and the second electronic device.

20. The system according to claim 18, wherein the processing unit is further operable to select an application for delivery to both the first electronic device and the second electronic device, wherein the selected application to be delivered to the first electronic device is an application that is formatted for the operating environment of the first electronic device and the selected application to be delivered to the second electronic device is an application that is formatted for the operating environment of the second electronic device.

21. The system according to claim 20, wherein the processing unit is further operable to determine a bulk delivery fee for the delivery of the application to the first electronic device and the second electronic device.

22. The system according to claim 20, wherein the processing unit is further operable to determine the operating environment of the first electronic device and the second electronic device for selecting the application for delivery to the first electronic device and to the second electronic device.

23. The system according to claim 17, wherein the application memory component, the interface and the processing unit are part of an electronic application store that offers the plurality of applications for download to the electronic devices.

24. The system according to claim 23, wherein the application memory component is operable to segment the offered applications of the electronic application store based on the operating environments for which the offered applications are formatted.

25. The system according to claim 17, wherein the electronic devices are mobile communication devices and the operating environments include operating systems that are loaded on the mobile communication devices.

26. A system for automatic provisioning of applications to a plurality of electronic devices having different operating environments, comprising:
an application memory component, wherein the application memory component is operable to store a plurality of applications for download to electronic devices, wherein each of at least some of the applications are formatted for one of a plurality of operating environments of the electronic devices;
an interface, wherein the interface is operable to receive a request for at least one application for delivery to a first electronic device and a second electronic device, wherein the operating environment of the first electronic device is different from the operating environment of the second electronic device; and
a processing unit that is communicatively coupled to the application memory component and the interface, wherein the processing unit is operable to select an application for delivery to the first electronic device and to the second electronic device, wherein the application to be delivered to the first electronic device is a version of the selected application that is formatted for the operating environment of the first electronic device and the application to be delivered to the second electronic device is a version of the selected application that is formatted for the operating environment of the second electronic device.

27. The system according to claim 26, wherein the application memory component, the interface and the processing unit form part of an electronic application store that is accessible by the plurality of electronic devices having the different operating environments.

28. The system according to claim 26, wherein the interface is further operable to receive the request for the application for delivery to the first electronic device and the second electronic device from the first electronic device or from another component separate from the first electronic device and the second electronic device.

29. A method for automatic provisioning of content to a plurality of electronic devices having different operating environments, comprising:
offering content for download to the electronic devices, wherein some of the offered content is formatted for a first one of the different operating environments of the electronic devices and some of the offered content is formatted for a second one of the different operating environments;
receiving a request for content for a first electronic device and a second electronic device, wherein the first electronic device and the second electronic device have different operating environments; and
selecting the content for delivery to the first electronic device and the second electronic device, wherein the content to be delivered to the first electronic device is content that is formatted for the operating environment for the first electronic device and the content to be delivered to the second electronic device is content that is formatted for the operating environment for the second electronic device.
